(19) United States
(12) Patent Application Publication
(10) Pub. No.: US 2006/0043937 A1
(43) Pub. Date: Mar. 2, 2006

(54) Method and system for obtaining ambient temperatures

(76) Inventors: Joseph Patino, Pembroke Pines, FL (US); Russell L. Simpson, Miami, FL (US)

Correspondence Address: Larry G. Brown;Motorola, Inc., Law Department, 8000 West Sunrise Boulevard, Fort Lauderdale, FL, 33322, US

(21) Appl. No.: 10/930,559

(22) Filed: Aug. 31, 2004

(51) Int. Cl. H02J 7/04; H02J 7/00

(52) U.S. Cl. 320/150; 320/134

(57) ABSTRACT

The invention concerns a method (300) and system (100) for obtaining ambient temperatures. The method can include the steps of coupling (312) an accessory (112) having a first temperature monitor (170) to a portable electronic device (110), operating (314) a power source (114) of the portable electronic device and monitoring (318) an ambient temperature with the first temperature monitor and a temperature of the power source. The method can also include the steps of discontinuing (322) operation of the power source if the temperature of the power source reaches a predetermined threshold and reinitiating (328) the operation of the power source if it is determined (324) that the ambient temperature was within a predetermined range of the predetermined threshold and that the ambient temperature is outside the predetermined range.

### BACKGROUND OF THE INVENTION

1. Field of the Invention

This invention relates in general to obtaining ambient temperatures and more particularly, to obtaining ambient temperatures in and around portable electronic devices.

2. Description of the Related Art

In recent years, portable electronic devices, such as cellular telephones, personal digital assistants and gaming devices, have become commonplace. Many of these devices are designed to receive accessories, which can increase their functionality. For example, most cellular telephones include receptacles that receive plugs from a headset or an earpiece. These types of accessories include speakers to enable a person to conduct a conversation without having to hold the cellular telephone.

In addition to accessories, virtually all portable electronic devices include one or more rechargeable batteries. These batteries are typically embedded with certain protection features. As an example, many batteries include mechanisms for monitoring their internal temperatures. If this temperature gets too high, the battery can be disabled, which can prevent the battery from being damaged.

Current mechanisms for measuring battery temperature suffer from several drawbacks. For example, the battery temperature is affected by the heat given off from components in the electronic device to which the battery is coupled. Also, ambient temperature can affect the temperature reading of the battery. These sources of heat can be referred to as passive sources of heat because they are not directly generated from the operation of the battery. Nevertheless, the battery will be disabled for its protection if its temperature reaches a maximum battery temperature. In either case, if the battery is being charged, the charging process will be stopped, and a user of the electronic device may receive a false notice that the battery is fully charged.

### SUMMARY OF THE INVENTION

The present invention concerns a method for obtaining ambient temperatures. The method can include the steps of coupling an accessory having a first temperature monitor to a portable electronic device, operating a power source of the portable electronic device and monitoring an ambient temperature with the first temperature monitor and a temperature of the power source. The method can further include the steps of discontinuing operation of the power source if the temperature of the power source reaches a predetermined threshold and reinitiating the operation of the power source. The operation of the power source can be reinitiated if it is determined that the ambient temperature was within a predetermined range of the predetermined threshold and that the ambient temperature is outside the predetermined range.

In one arrangement, the power source can include a second temperature monitor. The monitoring of the temperature of the power source can include, for example, monitoring the temperature of the power source with the second temperature monitor. The operating a power source step can also include either charging the power source or discharging the power source.

In another arrangement, the first temperature monitor can be a first thermistor, and the second temperature monitor can be a second thermistor. Also, the first thermistor can be coupled to an audio line having a speaker and can share a contact with the audio line. In another arrangement, the monitoring an ambient temperatures step can include comparing a calculated resistance of the first thermistor with a set of predetermined values in a memory.

The method can further include the steps of monitoring a user temperature with the first temperature monitor and providing the user temperature to a user through a user interface section of the portable electronic device. As another example, the accessory can be a headset or a speaker enclosure.

The present invention also concerns a system for obtaining ambient temperatures. The system can include an accessory and a portable electronic device having a power source in which the power source can be attachable to and can provide power to the portable electronic device. The accessory can be attachable to the portable electronic device, and the accessory can have a first temperature monitor. The portable electronic device can further include a second temperature monitor and a processor in which the second temperature monitor can be coupled to the processor.

The processor can be programmed to operate the power source of the portable electronic device, monitor an ambient temperature through the first temperature monitor and a temperature of the power source through the second temperature monitor and discontinue operation of the power source if the temperature of the power source reaches a predetermined threshold. The processor can be further programmed to reinitiate the operation of the power source if the processor determines that the ambient temperature was within a predetermined range of the predetermined threshold and that the ambient temperature is outside the predetermined range. The system can also include suitable software and/or circuitry to carry out the processes described above.

The present invention also concerns an accessory for obtaining ambient temperatures. The accessory can include a first temperature monitor for measuring an ambient temperature and a user interface line. In one arrangement, the accessory can be attachable to a portable electronic device having a power source. The portable electronic device can monitor an ambient temperature through the first temperature monitor and can discontinue operation of the power source if the temperature of the power source reaches a predetermined threshold. The portable electronic device can also reinitiate the operation of the power source if the ambient temperature was within a predetermined range of the predetermined threshold and the ambient temperature is outside the predetermined range.

As an example, the first temperature monitor can measure a temperature of a user, and the portable electronic device can provide the user with the measured temperature. In another arrangement, the user interface line can be an audio line having a speaker and a contact. The first temperature monitor can be coupled to the audio line and can share the contact with the audio line.

The present invention also concerns an accessory for measuring temperature. The accessory can include a user interface line in which the user interface line can contain one or more user interface components that can provide information to or receive information from a user. The user interface line can include a contact. The accessory can also include a temperature monitor in which the temperature monitor can be used to measure temperature. The temperature monitor can also be coupled to the user interface line and can share the contact with the user interface line. As an example, the temperature monitor can be a thermistor, the user interface line can be an audio line and the user interface component can be a speaker. The thermistor can be used to measure an ambient temperature.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for obtaining ambient temperatures in accordance with an embodiment of the inventive arrangements;

FIG. 2 illustrates an example of a block diagram of several components of FIG. 1 in accordance with an embodiment of the inventive arrangements;

FIG. 3 illustrates a portion of a method for obtaining ambient temperatures in accordance with an embodiment of the inventive arrangements; and

FIG. 4 illustrates another portion of the method of FIG. 3 for obtaining ambient temperatures in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention presents a method and system for obtaining ambient temperatures. In one arrangement, the method can include the steps of coupling an accessory having a first temperature monitor to a portable electronic device, operating a power source of the portable electronic device and monitoring an ambient temperature with the first temperature monitor and a temperature of the power source. The method can further include the steps of discontinuing operation of the power source if the temperature of the power source reaches a predetermined threshold and reinitiating the operation of the power source. The reinitiation may occur if it is determined that the ambient temperature was within a predetermined range of the predetermined threshold and that the ambient temperature is outside the predetermined range.

As an example, the operating a power source step can include either the process of charging the power source or the process of discharging the power source. The accessory can also include a user interface line containing user interface components that provide information to a user. The user interface line may also include a contact. In another arrangement, the first temperature monitor can be coupled to the user interface line and can share the contact with the user interface line.

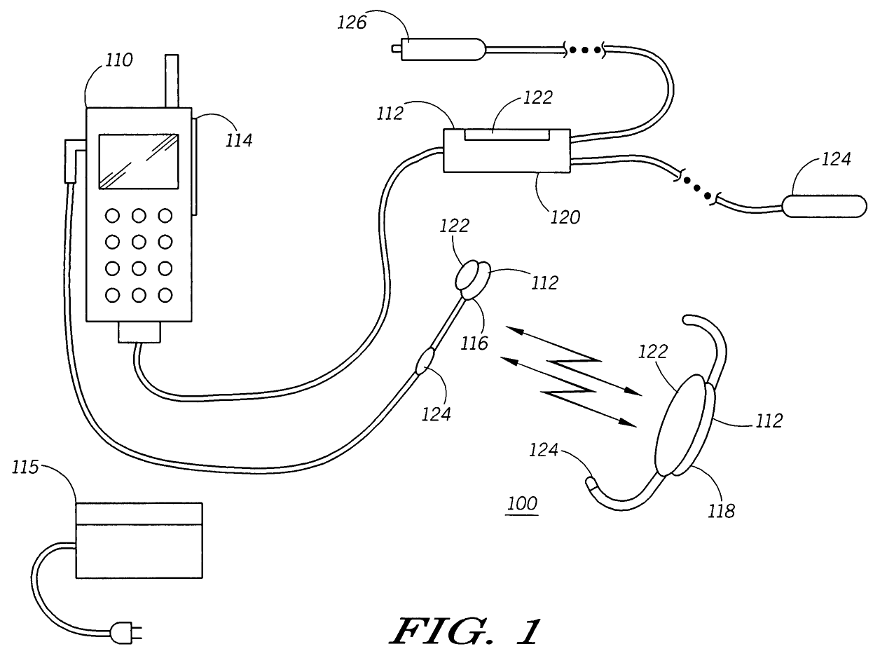

Referring to FIG. 1, a system 100 for obtaining ambient temperatures is shown. In one arrangement, the system 100 can include a portable electronic device 110 and one or more accessories 112. The portable electronic device 110 can also include a power source 114 that can provide power to the portable electronic device 110. The system 100 may also include a charging unit 115, which can provide current to the portable electronic device 110 and/or the power source 114.

As an example, the portable electronic device 110 can be a telecommunications unit, such as a cellular telephone, personal digital assistant, two-way radio or the like. As another example, the power source 114 can be a rechargeable battery, although other suitable components for providing power may be employed. The accessory 112 can be any component that, when coupled to the portable electronic device 110, can provide additional features or capabilities to the functionality of the portable electronic device 110. The accessory 112 can be coupled to the portable electronic device 110 through, for example, a conventional hard-wired connection or a wireless link.

In one particular example, the accessory 112 can be a headset or a speaker enclosure. Specifically, the accessory 112 can be a headset 116, a wireless headset 118 or a speaker enclosure 120. Through these accessories 112, a user can conduct conversations through the portable electronic device 110. As pictured, the headset 116 can include a speaker 122 for broadcasting audio signals and a microphone 124 for capturing audio signals. The wireless headset 118 can also include a speaker 122 and a microphone 124 and, as those of skill in the art will appreciate, can have a transceiver (not shown) to enable wireless transmission of signals. In addition, the speaker enclosure 120 can have a speaker 122 and a microphone 124. The speaker enclosure 120 can also include a power connector 126 that can receive power from a suitable connection source in a vehicle. As may be appreciated, the speaker enclosure 120 is commonly referred to as a car kit. It must be stressed, however, that the portable electronic device 110 is not limited to a telecommunications device, that the accessory 112 is not limited to a headset or a speaker enclosure and that the power source 114 is not limited to a rechargeable battery.

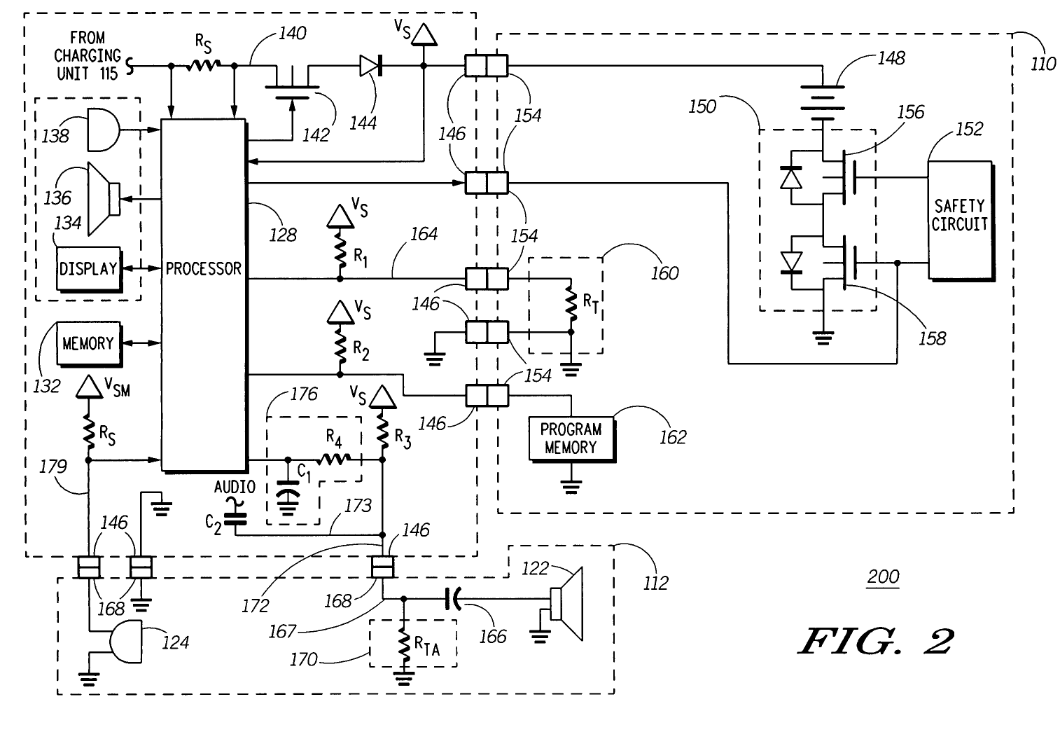

Referring to FIG. 2, a block diagram of several of the components of FIG. 1 is illustrated. In particular, the portable electronic device 110 can include a processor 128, a user interface section 130 coupled to the processor 128 and a memory 132. The user interface section 130 can be used to provide a user with data or information relating to the portable electronic device 110, the accessory 112, the power source 114 or any other suitable component. As an example, the user interface section 130 can include a display 134, a speaker 136 and a microphone 138. The memory 132 can store any suitable type of program or application, which can be accessed by the processor 128. In one particular example, the memory 132 can store sets of values that are related to the resistance of a thermistor, which, as will be explained, can be used to help determine certain temperatures.

The portable electronic device 110 can also include a charging line 140. The charging line 140 can include a sense resistor R_{S}, a charging switch 142 and a diode 144. The processor 128 can have inputs on both sides of the sense resistor R_{S}, which can enable the processor 128 to monitor the charging of the power source 114. The processor 128 can also control the operation of the switch 142, meaning the processor can control the flow of current from the charging unit 115 to the power source 114. The portable electronic device 110 can also include power source contacts 146, and the charging line 140 can feed into one of the power source contacts 146.

In one arrangement, the power source 114 can include a number of cells 148, a switch 150 coupled to the cells 148 and a safety circuit 152 coupled to the switch 150. The power source 114 can also include a number of contacts 154, and the cells 148 can be coupled to one of these contacts 154. Through the contact 154 of the power source 114 and the contact 146 of the portable electronic device 110, the cells 148 can receive a charging current and can also discharge current to the appropriate components of the portable electronic device 110. When discharging, power can be provided to the components of the portable electronic device 110 through the voltage supply V_{S} connection that taps off the charging line 140.

The switch 150 can include an overvoltage field effect transistor (OVFET) 156 and an undervoltage field effect transistor (UVFET) 158. As those of skill in the art will appreciate, if the voltage of the power source 114 becomes too high, the safety circuit 152 can turn off the OVFET 156. Likewise, if the voltage of the power source 114 becomes too low, the safety circuit 152 can turn off the UVFET 158. In another arrangement, the processor 128 of the portable electronic device 110 can control the flow of current from the power source 114 by controlling the operation of the UVFET 158. This control can be made possible by coupling the processor 128 to the gate of the UVFET 158 through a contact 146 of the portable electronic device 110 and a contact 154 of the power source 114.

The power source 114 may also include a temperature monitor 160 and a programmable memory 162. The temperature monitor 160 can be coupled to another contact 154 of the power source 114. In addition, the processor 128 can be coupled to another contact 146 through a temperature line 164. A pull-up resistor R₁ can also be coupled to a voltage supply V_{S} and the temperature line 164. As an example, the temperature monitor 160 of the power source 114 can be a thermistor R_{T}. As is known in the art, the processor 128 can determine the temperature of the power source 114 through the voltage divider network created by the pull-up resistor R₁, the thermistor R_{T} and the voltage supply V_{S}.

The programmable memory 162 can be coupled to a contact 154 of the power source 114. Also, the processor 128 can be coupled to a contact 146 through a memory line 165, to which another pull-up resistor R₂ can be coupled. The pull-up resistor R₂ can also be coupled to a voltage supply V_{S}. Through the memory line 165 and the contacts 146, 154, the processor 128 can access data concerning the power source 114, as is known in the art. As an example, the programmable memory 162 can be an erasable programmable read only memory (EPROM) or an electrically erasable programmable read only memory (EEPROM). As also pictured in FIG. 2, the both the portable electronic device 110 and the power source 114 can have grounds that couple to the contacts 146 and 154, respectively.

As explained above, the system 100 can include an accessory 112 that can be coupled to the portable electronic device 110. In relation to FIG. 2, the accessory 112 that is shown is a headset 116 that can include a speaker 122 and a microphone 124. In one arrangement, the speaker 122 can be part of a user interface line 167, and a blocking capacitor 166 can also be an element of the user interface line 167. The user interface line 167 can be coupled to a contact 168 of the accessory 112. The user interface line 167 can include other suitable components, either in addition to or in lieu of the speaker 122 and the blocking capacitor 166, such as the microphone 124. These user interface components can be any user interface element that can provide information to or receive information from a user. In this arrangement, the user interface line 167 can be referred to as an audio line 167.

The accessory 112 can also include a temperature monitor 170, which can also be coupled to the audio line 167. The temperature monitor 170 may be referred to as a first temperature monitor, and the temperature monitor 160 may be referred to as a second temperature monitor.

The portable electronic device 110 can also include a user interface line 172, which can be coupled to a contact 146 of the portable electronic device 110. The user interface line 172 can also be referred to as an audio line 172. An audio input 173, for example, can feed into the audio line 172 of the portable electronic device 110 and a blocking capacitor C₂ can be part of this audio input 173. In addition, a voltage supply V_{S} can be coupled to the audio line 172 through a pull-up resistor R₃. An input 174 can run from the audio line 172 to the processor 128, and the input 174 can include a filter 176 for filtering out audio signals. As an example, the filter 176 can include a resistor R₄ and a capacitor C₁.

In one arrangement, the temperature monitor 170 can be a thermistor R_{TA}. As such, the processor 128 can determine the value of the thermistor R_{TA} through the voltage divider network created by the thermistor R_{TA}, the pull-up resistor R₃ and the voltage supply V_{S} and the measured voltage from the input line 174. Accordingly, the processor 128 can determine a temperature that exists at the accessory 112. In one example and as will be explained below, the measured temperature can be an ambient temperature present at the accessory 112. The thermistor R_{TA} can be referred to as a first thermistor and the thermistor R_{T} in the power source 114 can be referred to as a second thermistor.

In another example, the measured temperature can be the body temperature of a user of the accessory 112. In view of the temperature monitor 170 being coupled to the audio line 167, temperatures can be measured at the accessory 112 without the need for an additional contact between the accessory 112 and the portable electronic device 110. That is, the temperature monitor 170, e.g., the thermistor R_{TA}, can share a contact 168 with the audio line 167. Moreover, the temperature monitor 170 should not be affected by the heat given off from the components in the portable electronic device 110.

To receive audio input from the accessory 112, the microphone 124 can be coupled to a contact 168 of the accessory 112, and a microphone line 179 can be coupled to a contact 146 of the portable electronic device 110. A voltage supply V_{SM}, through a pull-up resistor R₅, can be coupled to the microphone line 179, which can also be coupled to the processor 128. The portable electronic device 110 and the accessory 112 can both have grounds, which can be coupled to the contacts 146 and 168, respectively.

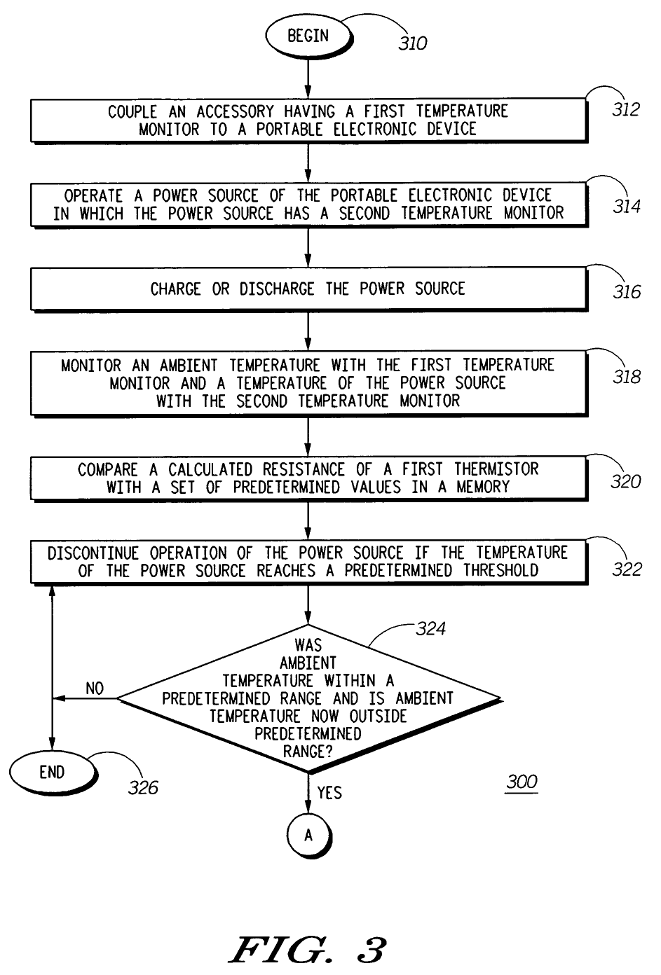

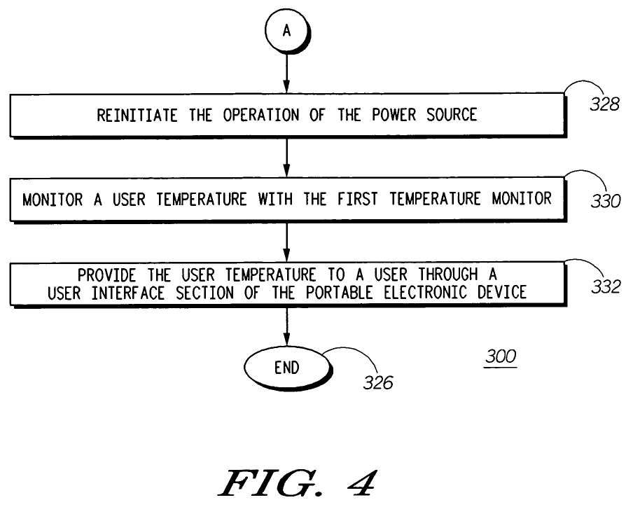

Referring to FIG. 3, a method 300 for obtaining ambient temperatures is shown. For purposes of the invention, ambient temperature can include any temperature that exists outside the portable electronic device, including temperatures of both animate and inanimate objects. To describe the method 300, reference may be made to FIGS. 1 and 2, although the method 300 can be practiced in other situations using any other suitable devices or systems. Moreover, the method 300 is not limited to the particular steps that are shown in FIG. 3 (or FIG. 4) or to the order in which they are depicted. The inventive method 300 may also include a fewer number of steps as compared to what is shown in FIG. 3 (and FIG. 4).

At step 310, the method 300 can begin. At step 312, an accessory having a first temperature monitor can be coupled to a portable electronic device. A power source of the portable electronic device can be operated in which the power source has a second temperature monitor, as shown at step 314. At step 316, the operating the power step can include either charging or discharging the power source.

Referring to FIGS. 1 and 2, an accessory 112 can be coupled to a portable electronic device 110. Coupling can include a hard-wired connection or a wireless connection. As described above, the accessory 112 can have a temperature monitor 170, i.e, a first temperature monitor. Numerous examples of portable electronic devices and accessories are within the realm of the inventive arrangements. The power source 114 of the portable electronic device 110 can be operated, and this power source 114, as noted earlier, can include a temperature monitor 160, which can be referred to as a second temperature monitor.

The power source 114 can be operated in several ways. For example, a charging current can be supplied from the charging unit 115 to the power source 114 through the charging line 140. By controlling the operation of the charging switch 142, the processor 128 can control the charging current that flows to the power source 114. As an example, if the temperature of the power source 114 exceeds a predetermined threshold, the processor 128 can turn off the charging switch 142, which can stop the charging of the power source 114.

Another example of operating the power source 114 is the discharging of the power source 114. In particular, the cells 148 of the power source 114 can provide power to the components of the portable electronic device 110, such as through the voltage supply connection VS coupled to the charging line 140. The processor 128 can also control this discharge current by managing the operation of the UVFET 158. For example, if the temperature of the power source 114 becomes too high, the processor 128 can deactivate the UVFET 158, which can prevent the power source 114 from discharging. Such a step may cause the portable electronic device 110 to power off. Of course, other methods of operating the power source 114 are within the scope of the inventive arrangements.

Referring back to the method 300, at step 318, an ambient temperature can be monitored with the first temperature monitor, and a temperature of the power source can be monitored with the second temperature monitor. At step 320, a calculated resistance of a first thermistor can be compared with a set of predetermined values in a memory. The operation of the power source can be discontinued if the temperature of the power source reaches a predetermined threshold, as shown at step 322.

For example, referring once again to FIGS. 1 and 2, the temperature monitor 170, which can be a thermistor R_{TA}, can be used to help obtain an ambient temperature. Specifically, the thermistor R_{TA} can be positioned near or on an outside surface of the accessory 112. Because the accessory 112 is typically positioned away from the portable electronic device 110, the resistance of the thermistor R_{TA} can be directly related to an ambient temperature.

Through the voltage divider network created by the thermistor R_{TA}, the pull-up resistor R₃ and the voltage supply V_{S}, the processor 128 can determine the voltage on the input line 174. The filter 176 can prevent audio signals from interfering with this measurement. The processor 128 can then calculate the resistance of the thermistor R_{TA} and can compare the calculated resistance to a set of predetermined values in the memory 132. These predetermined values in the memory 132 can correspond to predetermined temperatures. Through this comparison and the corresponding predetermined temperatures, the processor 128 can determine the temperature that is being measured by the R_{TA}.

The temperature of the power source 114 can be determined in a similar manner. For example, the processor 128 can determine the voltage on the temperature line 164 through the voltage divider network of the supply voltage V_{S}, the pull-up resistor R₁ and the thermistor R_{T}. In addition, the processor 128 can calculate the resistance of the thermistor R_{T}. The processor 128 can then determine the temperature of the power source 114 through the comparison of the calculated resistance, the predetermined values and the corresponding predetermined temperatures, as described above.

If the temperature of the power source 114 reaches a predetermined threshold, the processor 128 can discontinue operation of the power source 114. For example, if the power source 114 is being charged, the processor 128 can deactivate the charging switch 142, which can prevent charging current from reaching the power source 114. Alternatively, if the power source 114 is discharging, the processor 128 can turn off the UVFET 158. It is understood, however, that the invention is not so limited, as other steps can be taken to discontinue the operation of the power source 114.

Referring back to the method 300 of FIG. 4, at decision block 324, it can be determined whether the ambient temperature was within a predetermined range of the predetermined threshold and also whether the ambient temperature is now outside the predetermined range. If the ambient temperature was not within the predetermined range of the predetermined threshold, the method 300 can end at step 326. If the ambient temperature was within the predetermined range of the predetermined threshold and remains within the predetermined range, the method 300 can resume at step 322. If, however, the ambient temperature was within the predetermined range and has since moved outside the predetermined range, the method 300 can continue to step 328 of FIG. 4, through jump circle A. At step 328, the operation of the power source can be reinitiated.

For example, referring once again to FIGS. 1 and 2, the processor 128 can determine whether the ambient temperature was within a predetermined range of the predetermined threshold. The predetermined threshold can be the temperature at which the processor 128 disables the power source 114, and the predetermined range may be a percentage of the predetermined threshold. As a more specific example but without limitation, the predetermined range can be within minus ten percent of the predetermined threshold.

The processor 128 can also determine whether the ambient temperature has since moved outside the predetermined range. In accordance with the above example, the processor 128 can determine whether the ambient temperature has moved outside minus ten percent of the predetermined range. Again, this particular range is merely an example, as other values can be employed.

If the processor 128 determines that the ambient temperature was outside the predetermined range when the power source 114 was disabled, the processor 128 can maintain the power source 114 in a disabled state. The power source 114 may remain in the disabled state until, for example, the user attempts to recharge the power source 114 or turns the portable electronic device 110 back on. Of course, if the temperature of the power source 114 is still at or above the predetermined threshold, the processor 128 may keep the power source 114 in the disabled state.

If the processor 128 determines that the ambient temperature was within the predetermined range when the power source 114 was disabled, the processor 128 can assess the ambient temperature again. If the ambient temperature remains in the predetermined range, the processor 128 can keep the power source 114 in the disabled state. The processor 128 can continue to monitor the ambient temperature at predetermined intervals, for example.

If the processor 128 determines that the ambient temperature has moved outside the predetermined range, the processor 128 can automatically reinitiate the operation of the power source 114. For example, the processor 128 can turn on the charging switch 142 to permit the power source 114 to be charged again. As another example, the processor 128 can activate the UVFET 158, which can permit the power source 114 to provide power to the portable electronic device 110. To enable this procedure of activating the UVFET 158, the processor 128 can receive its power from, for example, the charging unit 115 or any other suitable source of power. If no additional power supply is available, the power source 114 can remain in the disabled state by default.

In accordance with the example described above, the operation of the power source 114 can be automatically reinitiated based on an ambient temperature. Specifically, if the ambient temperature is high, e.g., within the predetermined range of the predetermined threshold, the ambient temperature may be contributing to the excessive temperature to which the power source 114 is being subjected. Once this ambient temperatures drops, for example, the operation of the power source 114 can be automatically restarted with the concern over damaging the power source 114 being lessened.

Referring back to the method 300 of FIG. 4, another example of the monitoring of an ambient temperature is presented. At step 330, a user temperature can be monitored with the first temperature monitor. At step 332, the user temperature can be provided to a user through a user interface section of the portable electronic device. The method 300 can end at step 326.

For example, referring back to FIG. 2, the accessory 112 may include a speaker 122 that can be inserted in a body cavity of a user, such as an outer ear canal. As a result, the temperature that is related to the resistance of the thermistor R_{TA} in the accessory 112 can be a body temperature of a user. The processor 128, through the examples described above, can calculate this temperature and can signal any suitable component of the user interface section 130 to provide a user with this temperature. As an example, the temperature can be displayed on the display 134 or broadcast on the speaker 136. It is understood that the invention is in now way limited to these examples of obtaining ambient temperatures, as other suitable temperatures can be measured, regardless of whether they may affect the operation of the power source 114.

The present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product, which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for obtaining ambient temperatures, comprising the steps of:
coupling an accessory having a first temperature monitor to a portable electronic device;
operating a power source of the portable electronic device;
monitoring an ambient temperature with the first temperature monitor and a temperature of the power source;
discontinuing operation of the power source if the temperature of the power source reaches a predetermined threshold; and
reinitiating the operation of the power source if it is determined that the ambient temperature was within a predetermined range of the predetermined threshold and that the ambient temperature is outside the predetermined range.

2. The method according to claim 1, wherein the power source includes a second temperature monitor and the monitoring the temperature of the power source comprises monitoring the temperature of the power source with the second temperature monitor.

3. The method according to claim 1, wherein the operating a power source step comprises at least one of charging the power source and discharging the power source.

4. The method according to claim 1, wherein the first temperature monitor is a first thermistor and the second temperature monitor is a second thermistor.

5. The method according to claim 4, wherein the first thermistor is coupled to an audio line having a speaker and shares a contact with the audio line.

6. The method according to claim 4, wherein the monitoring an ambient temperatures step comprises comparing a calculated resistance of the first thermistor with a set of predetermined values in a memory.

7. The method according to claim 1, further comprising the steps of:
monitoring a user temperature with the first temperature monitor; and
providing the user temperature to a user through a user interface section of the portable electronic device.

8. The method according to claim 1, wherein the accessory is at least one of a headset and a speaker enclosure.

9. A system for obtaining ambient temperatures, comprising:
a portable electronic device having a power source, wherein the power source is attachable to and provides power to the portable electronic device; and
an accessory, wherein the accessory is attachable to the portable electronic device and the accessory has a first temperature monitor and the portable electronic device further includes a second temperature monitor and a processor, wherein the second temperature monitor is coupled to the processor;
wherein the processor is programmed to:
operate the power source of the portable electronic device;
monitor an ambient temperature through the first temperature monitor and a temperature of the power source through the second temperature monitor;
discontinue operation of the power source if the temperature of the power source reaches a predetermined threshold; and
reinitiate the operation of the power source if the processor determines that the ambient temperature was within a predetermined range of the predetermined threshold and that the ambient temperature is outside the predetermined range.

10. The system according to claim 9, wherein the processor is further programmed to operate the power source by at least one of permitting the charging of the power source and permitting the discharging of the power source.

11. The system according to claim 9, wherein the first temperature monitor is a first thermistor and the second temperature monitor is a second thermistor.

12. The system according to claim 11, wherein the accessory further comprises an audio line having a speaker and a contact and the first thermistor is coupled to the audio line and shares the contact with the audio line.

13. The system according to claim 11, wherein the portable electronic device further comprises a memory having a set of predetermined values and wherein the processor is further programmed to compare a calculated resistance of the first thermistor with the set of predetermined values.

14. The system according to claim 9, wherein the portable electronic device further includes a user interface section and the processor is further programmed to monitor a user temperature through the first temperature monitor and to provide the user temperature to a user through the user interface section.

15. The system according to claim 9, wherein the accessory is at least one of a headset and a speaker enclosure.

16. An accessory for obtaining ambient temperatures, comprising:
a first temperature monitor for measuring an ambient temperature; and
a user interface line;
wherein the accessory is attachable to a portable electronic device having a power source, wherein the portable electronic device monitors an ambient temperature through the first temperature monitor and discontinues operation of the power source if the temperature of the power source reaches a predetermined threshold and reinitiates the operation of the power source if the ambient temperature was within a predetermined range of the predetermined threshold and the ambient temperature is outside the predetermined range.

17. The accessory according to claim 16, wherein the first temperature monitor measures a temperature of a user and the portable electronic device provides the user with the measured temperature.

18. The accessory according to claim 16, wherein the user interface line is an audio line having a speaker and a contact, wherein the first temperature monitor is coupled to the audio line and shares the contact with the audio line.

19. An accessory for measuring temperature, comprising:
a user interface line, wherein the user interface line contains at least one user interface component that can perform one of providing information to or receiving information from a user, wherein the user interface line also includes a contact; and
a temperature monitor, wherein the temperature monitor is used to measure temperature and wherein the temperature monitor is coupled to the user interface line and shares the contact with the user interface line.

20. The accessory according to claim 19, wherein the temperature monitor is a thermistor, the user interface line is an audio line and the user interface component is a speaker and wherein the thermistor is used to measure an ambient temperature.
